(19) United States
(12) Patent Application Publication
(10) Pub. No.: US 2024/0396983 A1
(43) Pub. Date: Nov. 28, 2024

(54) TOE-BASED NETWORK INTERFACE DEVICE CAPABLE OF ENHANCING DATA PROCESSING EFFICIENCY, OPERATING METHOD THEREOF, AND SERVER DEVICE INCLUDING THE SAME

(71) Applicant: MangoBoost Inc., Seoul (KR)

(72) Inventors: Yujin Chung, Seoul (KR); Junehyuk Boo, Seoul (KR); Dongju Chae, Seoul (KR)

(21) Appl. No.: 18/673,335

(22) Filed: May 24, 2024

(30) Foreign Application Priority Data
May 26, 2023 (KR) 10-2023-0068675
Apr. 30, 2024 (KR) 10-2024-0058180

(51) Int. Cl. H04L 69/163; H04L 47/193

(52) U.S. Cl. CPC H04L 69/163; H04L 47/193

(57) ABSTRACT

A server device includes: a host device including a TCP data buffer configured to store a first data of a first request to be transmitted to a network, and a host device including a first command queue configured to store a first parameter of the first request including a first sequence number for the first data; and a network interface device configured to receive the first parameter from the first command queue, fetch the first data from a region corresponding to the first sequence number, within the TCP data buffer, and generate it as a first TCP packet for the first request.

### CROSS-REFERENCE TO RELATED APPLICATION(S)

This application claims benefit of priority to Korean Patent Application Nos. 10-2023-0068675, filed on May 26, 2023, and 10-2024-0058180, filed on Apr. 30, 2024, in the Korean Intellectual Property Office, the disclosures of which are incorporated herein by reference in their entirety.

### BACKGROUND

The present disclosure relates to a network interface, more specifically, relates to a TCP/IP Offload Engine (TOE) based network interface device capable of enhancing data processing efficiency, an operating method thereof, and a server device including the same.

The application of big data or artificial intelligence is expanding and the use of over-the-top (OTT) services becomes almost routine. As a result, there is an urgent need to improve the performance of various devices connected through the network, such as user terminals, web servers, web application servers (WAS), storage servers, and database servers, in terms of data processing volume and processing speed.

Specifically, network devices may require enormous system resources to perform data communication based on the Transmission Control Protocol/Internet Protocol (TCP/IP) Protocol in a high-speed network environment. For example, when a web server performs data communication with a large number of user terminals over a network, the web server's central processing unit (CPU) may experience a significant load to perform TCP/IP operations. This may cause performance degradation and communication delays throughout the web server.

Thus, various technologies have emerged to distribute the load of the CPU on network devices, among which the TCP/IP Offload Engine (TOE) technology is a technology that offloads the CPU load by implementing the transport layer and network layer, which were previously implemented in software in TCP/IP, as separate hardware (e.g., Network Interface Card). TOE technology to implement high-speed network environments requires efficient and flexible hardware or software design, such as high performance and multiple connection support.

### SUMMARY

The present disclosure is intended to provide a high-performance TOE-based network interface device capable of enhancing data processing efficiency by efficiently controlling and utilizing system resources in a high-speed network environment, a method of operation thereof, and a server device including the same.

According to an example embodiment of the present disclosure, a server device includes: a host device including a TCP data buffer configured to store a first data of a first request to be transmitted to a network, and a host device including a first command queue configured to store a first parameter of the first request including a first sequence number for the first data; and a network interface device configured to receive the first parameter from the first command queue, fetch the first data from a region corresponding to the first sequence number, within the TCP data buffer, and generate it as a first TCP packet for the first request.

According to an example embodiment of the present disclosure, a network interface device includes: a TCP controller configured to generate a first header information by performing a TCP operation on a received first request; a host interface configured to receive a first data corresponding to the first request from an external source in response to a first access signal that includes an information corresponding to a sequence number for a first data of the first request; and a packet generator configured to generate a first packet corresponding to the first request by receiving the first header information from the TCP controller, and receiving the first data from the host interface.

According to an example embodiment of the present disclosure, a method of operating of the network interface device includes: receiving the first request from the external source by the host interface; generating the first header information by performing the TCP operation for the first request by the TCP controller; receiving the first data from an external source by way of DMA, in response to the first access signal, by the host interface; and generating the first TCP packet by receiving the first header information from the TCP controller, and by receiving the first data from the host interface without being buffered or copied by the packet generator.

According to an example embodiment of the present disclosure, a TOE-based network interface device, a method of operation thereof, and a server device including the same, the efficiency of data processing can be improved by addressing a TCP data buffer with a sequence number of data.

Alternatively, according to an example embodiment of the present disclosure, a TOE-based network interface device, a method of operating thereof, and a server device including the same, memory usage can be significantly reduced and the efficiency of data processing can be improved as TCP data is buffered in a host device and is not additionally buffered or copied within the network interface device.

The effects of the exemplary embodiments of the present disclosure are not limited to those described above, and other effects not described may be clearly derived and understood by persons of ordinary skill in the art to which the exemplary embodiments of the present disclosure belong from the following description. In other words, unintended effects of implementing the exemplary embodiments of the present disclosure may also be derived from the exemplary embodiments of the present disclosure by persons of ordinary skill in the art.

### BRIEF DESCRIPTION OF THE DRAWINGS

FIG. 1 is a diagram illustrating a server device, according to an example embodiment of the present disclosure;

FIGS. 2 and 3 are diagrams illustrating a TCP data buffer, respectively, according to an example embodiment of the present disclosure;

FIG. 4 is a diagram conceptually illustrating an operation in which a host device transmits a first data to a network interface device in a server device, according to an example embodiment of the present disclosure;

FIG. 5 is a diagram conceptually illustrating an operation in which a host device receives a second data from a network interface device in a server device according to an example embodiment of the present disclosure;

FIG. 6 is a diagram illustrating a TCP session table, according to embodiments of the present disclosure;

FIG. 7 is a diagram illustrating a server device, according to an example embodiment of the present disclosure;

FIG. 8 is a diagram illustrating a network interface device, according to an example embodiment of the present disclosure;

FIG. 9 is a diagram illustrating a packet generator, according to an example embodiment of the present disclosure.

### DETAILED DESCRIPTION

Hereinafter, embodiments of the present disclosure will be described in detail with reference to the drawings so that those skilled in the art to which the present disclosure pertains can easily practice the invention. However, the present disclosure may be implemented in various forms and is not limited to the example embodiments described herein. In relation to the description of the drawings, like or similar reference numerals may be used for like or similar components. Moreover, in the drawings and the related description, well-known functions and configurations may be omitted for clarity and conciseness.

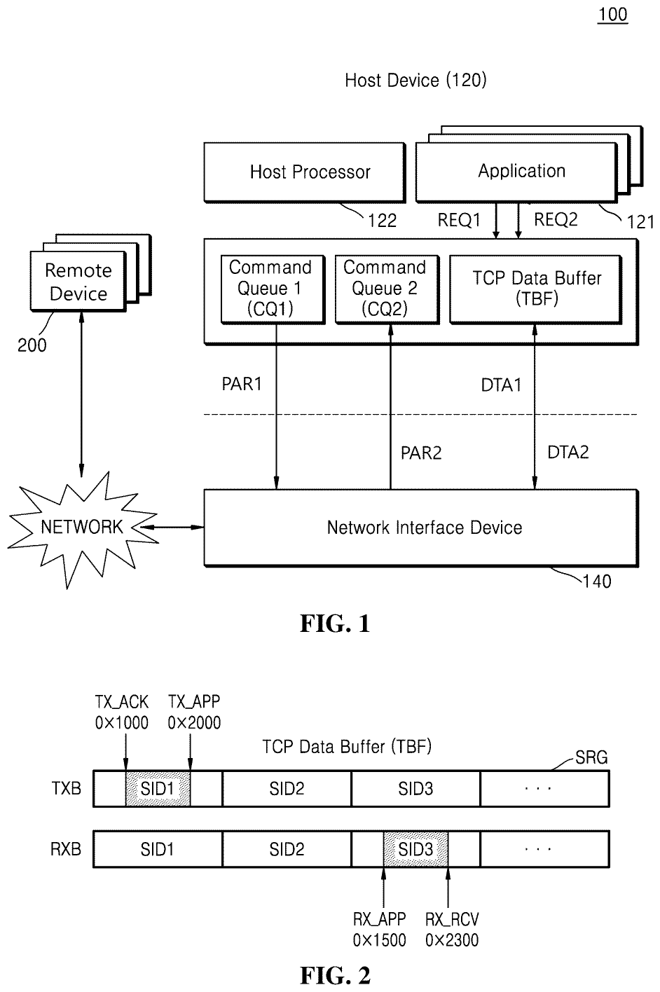

FIG. 1 is a diagram illustrating a server device, according to an example embodiment of the present disclosure.

Referring to FIG. 1, the server device 100 according to an example embodiment of the present disclosure includes a host device 120 and a TOE-based network interface device 140, and can efficiently perform TCP operations such as by addressing a buffer using a sequence number of a TCP data or directly processing a TCP data stored in the host device 120 without a separate internal buffer in the network interface device 140. To this end, the host device 120 may include a host processor 122, an application 121, a TCP data buffer TBF, a first command queue CQ1, and a second command queue CQ2.

The host processor 122 may control the overall operation and resource for processing a first request REQ1 and a second request REQ2 on the host device 120. The host processor 122 may be a host central processing unit (CPU). In the present disclosure, the host processor 122 may be understood as a concept that includes an operating system (OS) that operates in conjunction with the host CPU to process the first request REQ1 and the second request REQ2.

The application 121 may perform the user's request through a first data DTA1 of the first request REQ1 and a second data DTA2 of the second request REQ2.

The TCP data buffer TBF may store the first data DTA1 for the first request REQ1 or the second data DTA2 for the second request REQ2. The first command queue CQ1 may store the first request REQ1 including a first parameter PAR1, and the second command queue CQ2 may store information and a command related to the second request REQ2. The information and the command about the second request REQ2 are transmitted from the network interface device 140, for example, may be the result of a TCP operation for header information of a TCP packet received from a network and the command related thereto. In the present disclosure, for the convenience of explanation, the information stored in the command queue CQ2 related to the second request REQ2 may also be referred to as a second parameter PAR2, which will be described later. The first command queue CQ1 and the second command queue CQ2 may be implemented in the form of a command ring, respectively.

The server device 100 and a remote device 200 may be connected in a TCP session over a network to perform communication. The TCP session may mean a communication path between the server device 100 and the remote device 200 that is connected through a network, which may be specified by an IP address and port number and identified by a flow ID. In the present disclosure, the TCP session may be understood as the same meaning as a TCP connection.

The first request REQ1 may be a command that the application 121 is to send to the remote device 200, for example, “send ( )”. The second request REQ2 may be a command that the application 121 is to receive from the remote device 200, for example, “recv ( )”. The first request REQ1 may be implemented in a packed form containing the command (e.g., “send”), the flow ID, and the first parameter PAR1 for the first data DTA1. The second request REQ2 may be implemented in a packed form containing the command (e.g., “recv”), the flow ID, and the second parameter PAR2 for the second data DTA2.

In this case, in a precise meaning, the command “recv” of the second request “recv ( )” is a command to read the second data DTA2 that the application 121 is to receive from the TCP data buffer TBF and to indicate that the read operation is complete. However, for the convenience of explanation, unless otherwise mentioned in the present disclosure, matters related to the second request REQ2 should be understood as a concept that includes commands or events in a sequence of processes by which the application 121 obtains the second data DTA2 after the network interface device 140 receives the TCP packet from the remote device 200.

Accordingly, just as the information delivered to the aforementioned second command queue (CQ2) can be referred to as the second parameter (PAR2), in the present disclosure, a data that the network interface device 140 delivers it to the host device 120 may also be described as the second data DTA2. In addition, in the present disclosure, “request” including the first request REQ1 or the second request REQ2, may be understood as synonymous with “command”, “event”, “function”, as needed.

The first data DTA1 and second data DTA2 may have an arbitrary size, from a single byte to thousands of bytes, consistent with the TCP protocol, where a sequence number may be assigned to each byte. For example, the last sequence numbers of the first data DTA1 and second data DTA2 may be calculated using the sequence numbers of the respective data and the last sequence numbers of the previous data. The first data DTA1 may first be stored in the TCP data buffer TBF before being delivered to the network interface device 140. The second data DTA2 may first be stored in the TCP data buffer TBF before being delivered to the application 121.

The first parameter PAR1 and the second parameter PAR2 may include information about the TCP session, such as a flow ID identifying the respective TCP session, and the sequence numbers of the first data DTA1 and the second data DTA2. The first parameter PAR1 may include information about the entire sequence number of the first data DTA1 in various ways, such as including the first sequence number and the last sequence number of the first data DTA1, or including the first sequence number of the first data DTA1 and the length of the first data DTA1. The same may apply to the second parameter PAR2.

The TCP data buffer TBF according to an example embodiment of the present disclosure is configured and operated in a structure corresponding to the sequence numbers of the first data DTA1 and the second data DTA2, so that writing to and reading from the TCP data buffer TBF may be performed simply and efficiently, and the reliability of communication is ensured without performing additional copy operations of the first data DTA1 and the second data DTA2, and the memory usage of the network interface device 140 may be greatly reduced, and performance of transmission and reception of the first data DTA1 and the second data DTA2 between the host device 120 and the network interface device 140 may be improved. This will be described in detail below.

FIG. 2 is a diagram illustrating a TCP data buffer TBF according to an example embodiment of the present disclosure.

Referring to FIGS. 1 and 2, the TCP data buffer TBF according to an example embodiment of the present disclosure may include a transmit buffer TXB and a receive buffer RXB. The transmit buffer TXB may be a buffer storing the first data DTA1 that the application 121 is to transmit by the first request REQ1. The receive buffer RXB may be a buffer storing the second data DTA2 that the application 121 is to receive by the second request REQ2.

The transmit buffer TXB and the receive buffer RXB may each include sub-buffer regions SRG separately allocated for a unique TCP session. FIG. 2 illustrates an example embodiment where the transmit buffer TXB and the receive buffer RXB include the sub-buffer regions SRGs for a first TCP session SID1 to a third TCP session SID3, respectively.

In this case, the identifiers “SID1”, “SID2”, and “SID3” that specify the different TCP sessions may be the flow IDs described above. When a new TCP session is generated, the TCP data buffer TBF may allocate new sub-buffer region SRG for the added TCP session. In addition, the TCP data buffer TBF may reclaim the sub-buffer region SRG allocated for a closed TCP session among the first to third TCP sessions SID1 to SID3.

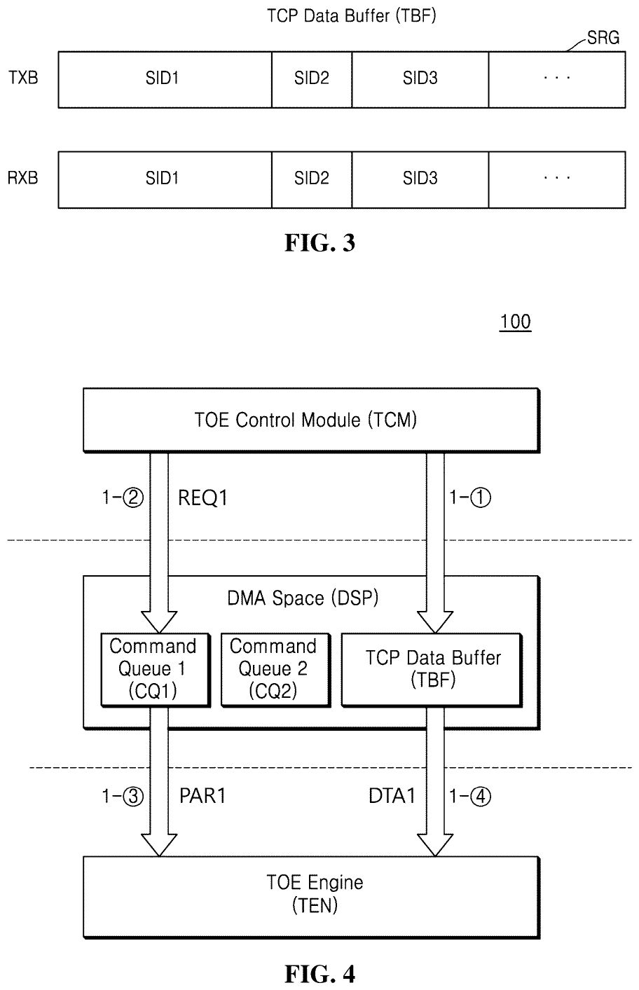

FIG. 3 is a diagram illustrating a TCP data buffer TBF according to an example embodiment of the present disclosure.

Referring to FIGS. 1 to 3, each sub-buffer region SRG may have a fixed size, as shown in FIG. 2. Alternatively, the size of all or some of the sub-buffer regions SRGs may be variable. The former may facilitate operational control over the TCP data buffer TBF, while the latter may enhance flexibility in the design or operation of the server device 100.

Further, the size of the sub-buffer regions SRGs for at least two TCP sessions may vary while each sub-buffer region SRG has a fixed size. In the example embodiment of FIG. 3, a larger sub-buffer region SRG is allocated to the first TCP session SID1 than to the second TCP session SID3 and the third TCP session SID3. Therefore, the server device 100 according to an example embodiment of the present disclosure may improve data processing performance despite the limited size of the TCP data buffer TBF by adaptively allocating the sub-buffer region SRG based on the characteristics of TCP sessions. For example, the server device 100 may allocate a relatively large sub-buffer region SRG to a TCP session with relatively high data throughput, such as OTT or AI computation.

Referring again to FIGS. 1 and 2, the TCP data buffer TBF may be addressed corresponding to the sequence number of the first data DTA1 or the second data DTA2. For example, the address of the TCP data buffer TBF may be set to the value of the least significant bits of the sequence number of the first data DTA1 or the second data DTA2. The number of least significant bits of the sequence number used for the TCP data buffer TBF may correspond to the size of the sub-buffer region SRG of the TCP data buffer TBF. For example, when the size of the sub-buffer region SRG for the first TCP session SID1 is 64 KB, the address of the TCP data buffer TBF may be set with the 16 least significant bits of the sequence number.

In other words, the first data DTA1 and the second data DTA2 according to the present disclosure may be stored in the regions within the TCP data buffer TBF that correspond to their respective sequence numbers.

For example, assume that the first data DTA1 is the data to be sent via the first request “send ( )” for the first TCP session SID1, and the last sequence number of the first data DTA1 is “0x11112000”. Further, assume that a data with the last sequence number “0x11111000” is written in the sub-buffer region SRG for the first TCP session SID1 of the transmit buffer TXB, within the TCP data buffer TBF. As described above, when the address of the TCP data buffer TBF is set with the 16 least significant bits of the first data DTA1, the host processor 122 of the host device 120 may write the first data DTA1 in the region from “0x1001” to “0x2000” of the corresponding sub-buffer region SRG.

For example, assume that the second data DTA2 is the data to be received via the data command “recv ( )” for the third TCP session SID3, and that the last sequence number of the second data DTA2 is “0x12342300”. Further, assume that a data with the last sequence number “0x12341500” is read out from the sub-buffer region SRG for the third TCP session SID3 of the receive buffer RXB, within the TCP data buffer TBF. As described above, when the address of the TCP data buffer TBF is set with the 16 least significant bits of the second data DTA2, the second data DTA2 may be written in the region from “0x1501” to “0x2300” of the corresponding sub-buffer region SRG. The operation of writing the second data DTA2 to the receive buffer RXB may be performed as a direct memory access (DMA) operation of the network interface device 140. This will be discussed in more detail below.

In this case, the valid region of the TCP data buffer TBF for a particular TCP session, namely the region in which data is written, may be identified or set by a pair of transmit offsets TX_APP and TX_ACK or a pair of receive offsets RX_APP and RX_RCV.

In the example embodiment of FIG. 2, the first transmit offset TX_APP of the pair of transmit offsets TX_APP and TX_ACK may correspond to the last sequence number of the first data DTA1 most recently requested for transmission by the application 121, and the second transmit offset TX_ACK may correspond to the last sequence number of the first data DTA1 most recently acknowledged in response to an existing data transmission request by the application 121. In other words, it may be that the first data DTA1 with the last sequence number corresponding to the second transmit offset TX_ACK has been acknowledged.

The first receive offset RX_APP of the pair of receive offsets RX_APP and RX_RCV may correspond to the last sequence number of the second data DTA2 most recently read by the application 121, and the second receive offset RX_RCV may correspond to the last sequence number of the second data DTA1 most recently received from the network interface device 140. In defining the transmit and receive offsets TX_APP, TX_ACK, RX_APP, and RX_RCV, the already processed first and second data DTA1 and DTA2 have been used as references, but it is not limited thereto. The transmit and receive offsets TX_APP, TX_ACK, RX_APP, and RX_RCV may also be defined based on the first and second data DTA1 and DTA2 to be newly processed. For example, the first transmit offset TX_APP may correspond to the first sequence number of the first data DTA1 that the application 121 is to transmit next, and the second transmit offset TX_ACK may correspond to the first sequence number of the first data DTA1 that needs to be ACK processed in the next sequence. Similarly, the first receive offset RX_APP may correspond to the first sequence number of the second data DTA2 that the application 121 is to read out next, and the second receive offset RX_RCV may correspond to the first sequence number of the second data DTA2 that needs to be ACK processed in the next sequence. However, for the convenience of explanation, the example embodiments concerning the transmit and receive offsets TX_APP, TX_ACK, RX_APP, and RX_RCV described later will be based on the already processed first data DTA1 and second data DTA2.

In this manner, the second transmit offset TX_ACK and the first receive offset RX_APP may be updated after processing the ACKs for the transmission of the first data DTA1 and the reception of the second data DTA2, respectively. This means that the first data DTA1 or the second data DTA2 is stored in the TCP data buffer TBF until the transmission of the first data DTA1 and the reception of the second data DTA2 is complete, namely, until the corresponding ACK is processed.

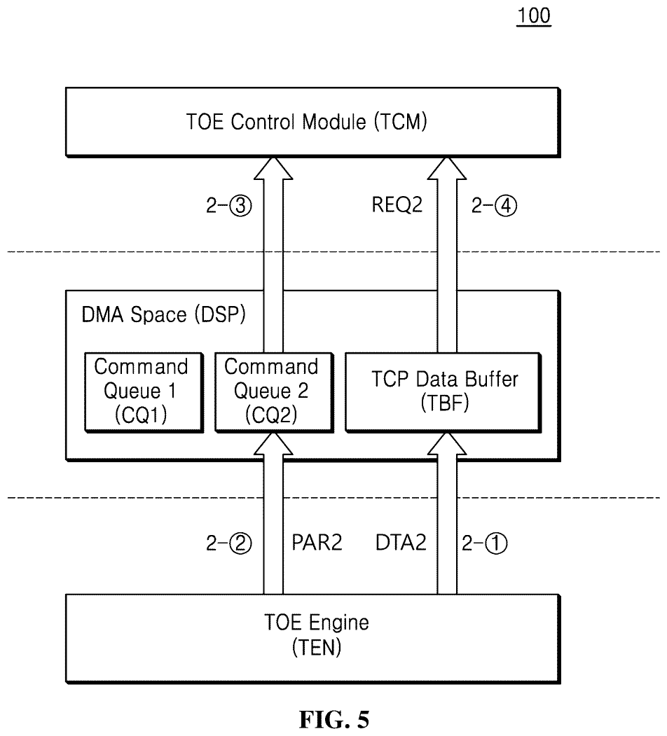

FIG. 4 is a diagram conceptually illustrating an operation in which the host device 120 transmits the first data DTA1 to the network interface device 140 in the server device 100 according to an example embodiment of the present disclosure, and FIG. 5 is a diagram conceptually illustrating an operation in which the host device 120 receives the second data DTA2 from the network interface device 140 in the server device 100 according to an example embodiment of the present disclosure.

Referring first to FIGS. 2 and 4, the server device 100 according to an example embodiment of the present disclosure may include a TOE control module TCM, a DMA space DSP, and a TOE engine TEN.

The TOE control module TCM and the DMA space DSP may be included in the host device 120. The TOE control module TCM may be implemented as a software stack that performs TOE managing. The TOE control module TCM may include software logic executed by the host processor 122 of FIG. 1 in processing the first request REQ1 or the second request REQ2. The DMA region DSP is implemented as a huge page and may include a first command queue CQ1, a second command queue CQ2, and the TCP data buffer TBF. The TOE control module TCM may generate the first command queue CQ1, the second command queue CQ2, and the TCP data buffer TBF in the DMA region DSP during an initialization phase.

The TOE engine TEN may be the network interface device 140 of FIG. 1 or may be included in the network interface device 140 of FIG. 1.

As the example embodiments described above, when the first request REQ1 is generated to transmit the first data DTA1 having a last sequence number of “0x11112000” for the first TCP session SID1, and the data up to “0x1000” is stored in the sub-buffer region SRG for the first TCP session SID1 of the transmit buffer TXB within the TCP data buffer TBF, the TOE control module TCM may first store the first data DTA1 at a location from “0x1001” to “0x2000” in the corresponding sub-buffer region SRG (1-\textcircled{1}). According to an example embodiment, it is not necessary for data to be stored up to “0x1000” in the relevant sub-buffer region SRG, the second transmit offset TX_ACK may need only indicate the position of the most recently used sub-buffer region SRG before writing new first data DTA1.

The TOE control module TCM may write the first request REQ1 including the sequence number of the first data DTA1 as one of the first parameters PAR1 in the first command queue CQ1 (1-\textcircled{2}). The operation (1-\textcircled{2}) of writing the first request REQ1 in the first command queue CQ1 may be performed, after the operation (1-\textcircled{1}) of storing the first data DTA1 in the TCP data buffer TBF is performed. However, it is not limited thereto, these operations may also be performed in a reversed order or may be performed simultaneously as needed.

When the first request REQ1 is written in the first command queue CQ1, the TOE control module TCM may notify the TOE engine TEN of the occurrence of the first request REQ1 via the memory-mapped I/O (MMIO) or the like. After that, the TOE engine TEN may receive the first request REQ1 from the first command queue CQ1 (1-\textcircled{3}). The TOE engine TEN may determine the sequence number for the first data DTA1 from the first parameter PAR1, and may fetch the first data DTA1 by accessing the TCP data buffer TBF at an address corresponding to the sequence number (1-\textcircled{4}). As described above, the sequence number for the first data DTA1 alone can determine where the first data DTA1 is stored in the TCP data buffer TBF, i.e., addresses “0x1001” to “0x2000” of the sub-buffer region SRG.

Next, referring to FIGS. 2 and 5, as the example embodiment described above, when the second data DTA2 having a last sequence number “0x12342300” for the third TCP session SID3 is received by the TOE engine TEN from the network, and the data up to “0x1500” is stored in the sub-buffer region SRG for the third TCP session SID3 of the receive buffer RXB within the TCP data buffer TBF, the TOE engine TEN may first store the second data DTA2 at a location from “0x1501” to “0x2300” in the sub-buffer region SRG by referring to the sequence number (2-\textcircled{1}). Similar to the case of FIG. 4 described above, it is not necessary for data to be stored up to “0x1500” in the relevant sub-buffer region SRG, the operation can function properly as long as the first receive offset RX_APP indicates that position.

Next, the TOE engine TEN may transmit the second parameter PAR2 including a sequence number of the second data DTA2 to the second command queue CQ2 (2-\textcircled{2}). However, this is not limited thereto, and the TOE engine TEN may perform the operation (2-\textcircled{2}) of transmitting the second parameter PAR2 to the second command queue CQ2 before or simultaneously with the operation (2-\textcircled{1}) of storing the second data DTA2 in the TCP data buffer TBF.

When the operation of storing the second data DTA2 in the TCP data buffer TBF is completed, or when both the operation of storing the second data DTA2 in the TCP data buffer TBF and the operation of transferring the second parameter PAR2 to the second command queue CQ2 are completed, the TOE engine TEN may inform the TOE control module TCM that the second data DTA2 and/or the second parameter PAR2 related to the TCP data reception have been transmitted. The TOE control module TCM may read out the second data DTA2 from the TCP data buffer TBF (2-\textcircled{4}) by referring to the sequence number included in the second parameter PAR2 with a second command queue CQ2 (2-\textcircled{3}).

According to the server device 100 and the method of operation thereof in an example embodiment of the present disclosure, communication between the host device 120 and the network interface device 140 may operate efficiently because it is known where to access the TCP data buffer TBF even if only the sequence number of the first data DTA1 or the second data DTA2 is shared.

Further, according to the server device 100 and operating method thereof in an example embodiment of the present disclosure, in performing the operation (1-\textcircled{3}) of receiving the first request REQ1 from the first command queue CQ1 and the operation (1-\textcircled{4}) of fetching the first data DTA1 from the TCP data buffer TBF, the TOE engine TEN may perform the TCP operation independently and asynchronously from the TOE control module TCM by applying the DMA method to the DMA area DSP. In the same way, in performing the operation (2-\textcircled{1}) of storing the second data DTA2 in the TCP data buffer TBF and the operation (2-\textcircled{2}) of transmitting the second parameter PAR2 to the second command queue CQ2, the TOE engine TEN may perform the TCP operation independently and asynchronously from the TOE control module TCM by applying the DMA method for the DMA area DSP. Since the first data DTA1 or the second data DTA2 of the TCP data buffer TBF is stored until it is acknowledged or delivered to the application 121, the same effect may be achieved even if the first data DTA1 or the second data DTA2 is lost during the communication process and the server device 100 performs a retransmission.

Thus, according to the server device 100 and operating method thereof in an example embodiment of the present disclosure, high-performance TOE operation may be supported while minimizing the burden on the host CPU.

In performing the above operations, the pair of transmit offsets TX_APP and TX_ACK and the pair of receive offsets RX_APP and RX_RCV indicating the state of the TCP data buffer TBF may be used by the TOE control module TCM or the host processor 122 to control the TCP data buffer TBF. This will be discussed in more detail below.

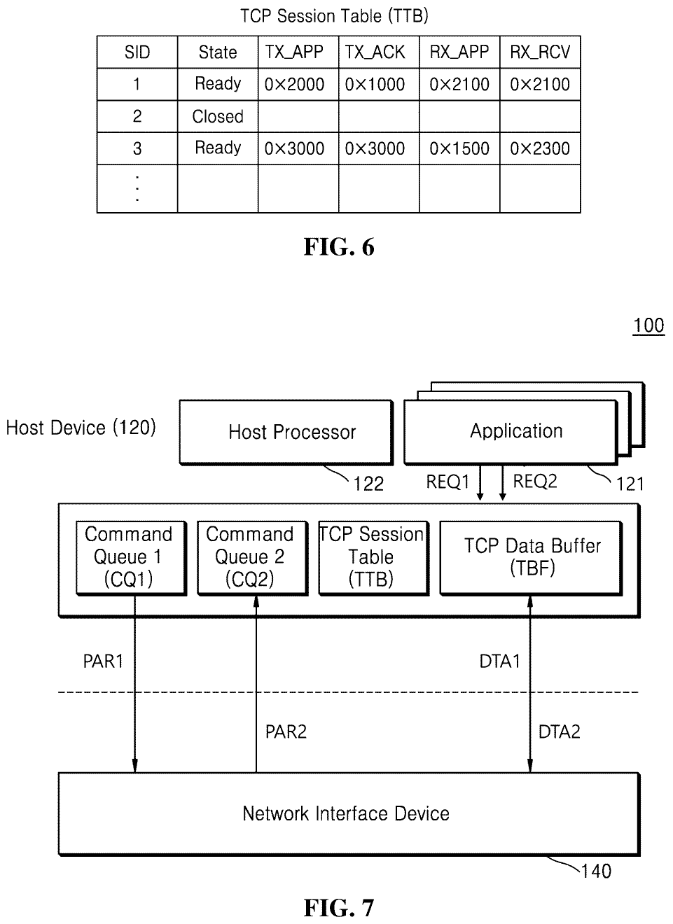

FIG. 6 is a diagram illustrating a TCP session table TTB, according to embodiments of the present disclosure, and FIG. 7 is a diagram illustrating a server device 100, according to an example embodiment of the present disclosure.

Referring to FIGS. 2, 6, and 7, the host device 120 of the server device 100 according to an example embodiment of the present disclosure may further include a TCP session table TTB. The TCP session table TTB may be included in fuzz page implemented in the host device 120 along with the TCP data buffer TBF and command queues CQ1 and CQ2.

The TCP session table TTB according to an example embodiment of the present disclosure may indicate the state of the TCP data buffer TBF via the first transmit offset TX_APP, the second transmit offset TX_ACK, the first receive offset RX_APP, and the second receive offset RX_RCV for each of the TCP sessions SID1 to SID3.

First, the difference between the first transmit offset TX_APP and the second transmit offset TX_ACK may correspond to the size of the first data DTA1, stored in the transmit buffer TXB, for the corresponding TCP session. When the address of the TCP data buffer TBF is set with 16 least significant bits of the first data DTA1 as described above, in the example embodiment of FIG. 2, the size of the first data DTA1 of the first TCP session SID1 currently stored in the transmit buffer TXB may be determined to be “0x1000”, which corresponds to the difference between the first transmit offset TX_APP “0x2000” and the second transmit offset TX_ACK “0x1000”.

In the same way, the difference between the first receive offset RX_APP and the second receive offset RX_RCV may correspond to the size of the second data DTA2 of the corresponding TCP session stored in the receive buffer RXB. When the address of the TCP data buffer TBF is set with 16 least significant bits of the second data DTA2 as described above, in the example embodiment of FIG. 2, the size of the second data DTA2 of the third TCP session SID3 currently stored in the receive buffer RXB may be determined to be “0xE00”, which corresponds to the difference between the first receive offset RX_APP “0x1500” and the second receive offset RX_RCV “0x2300”.

In addition, the first transmit offset TX_APP, the second transmit offset TX_ACK, the first receive offset RX_APP, and the second receive offset RX_RCV may change in value when the first data DTA1 or the second data DTA2 is written to or read from the TCP data buffer TBF, and the updated state of the TCP data buffer TBF may be confirmed.

When the first data DTA1 is written to the TCP data buffer TBF or the second data DTA2 is read out by the host device 120, the first transmit offset TX_APP or the first receive offset RX_APP may be increased. In contrast, when the first data DTA1 in the TCP data buffer TBF is acknowledged or the second data DTA2 is written to the TCP data buffer TBF by the network interface device 140, the second transmit offset TX_ACK or the second receive offset RX_RCV may be increased.

For example, when the first data DTA1 with the last sequence number “0x11113000” for the first TCP session SID1 is newly stored in the transmit buffer TXB, the first transmit offset TX_APP may be increased to “0x3000”. Alternatively, when the second data DTA2 with the last sequence number “0x12343000” for the third TCP session SID3 is newly stored in the receive buffer RXB, the second receive offset RX_RCV may be increased to “0x3000”. In response to these changes in the first transmit offset TX_APP, second transmit offset TX_ACK, first receive offset RX_APP, and second receive offset RX_RCV, the TCP session table TTB may be updated.

Further, in addition to the information about the state of the TCP data buffer TBF, the TCP session table TTB may also store information about the state of each of the TCP sessions SID1 to SID3.

In the example embodiment of FIG. 6, the first entry of the TCP session table TTB may store a state of “Ready” for the first TCP session SID1, and the second entry may store a state of “Closed” for the second TCP session SID2. In addition, in the third entry of the TCP session table TTB, the state of “Ready” for the third TCP session SID3 may be stored. “Ready” means the state of readiness for new events to occur in the corresponding TCP session, and “Closed” means the state of closing the corresponding TCP session. In the state of “Closed”, the information about the TCP session may be deleted.

Referring to the TCP session table TTB, the host processor 122 may control the operation of writing the first data DTA1 and the second data DTA2 into the TCP data buffer TBF or the operation of reading the first data DTA1 and the second data DTA2 out of the TCP data buffer TBF. For example, before the host processor 122 stores the first data DTA1 in the TCP data buffer TBF for processing of the first request REQ1 for the first TCP session SID1, the host processor 122 may refer to the TCP session table TTB to identify whether there is sufficient space in the sub-buffer region SRG for the first TCP session SID1 to store the first data DTA1. For example, the effective area of the corresponding sub-buffer region SRG may be determined from the difference between the first transmit offset TX_APP and the second transmit offset TX_ACK of the TCP session table TTB. By subtracting the effective area from the corresponding sub-buffer region SRG, the size of the storable space may be calculated, and the host processor 122 may compare the storable space to the size of the first data DTA1.

When there is not enough space in the sub-buffer region SRG for the first TCP session SID1 to store the first data DTA1, the host processor 122 may wait for a certain period or handle the first request REQ1 as an error immediately. Although not shown, the network interface device 140 may also include a table that stores offsets for the TCP data buffer TBF, similar to the TCP session table TTB of the host device 120, and may reference the table during operations for DMA transfer or DMA receive.

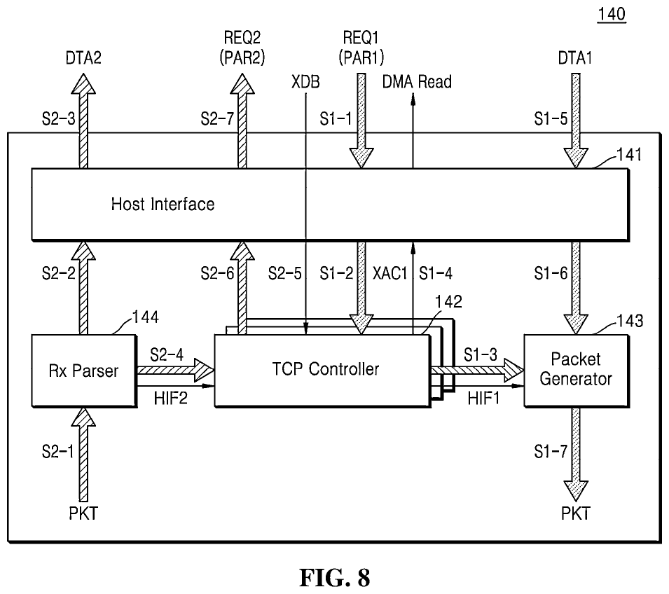

FIG. 8 is a diagram illustrating a network interface device 140 according to an example embodiment of the present disclosure.

Referring to FIGS. 1 and 8, the network interface device 140 according to an example embodiment of the present disclosure may generate a TCP packet PKT by receiving the first request REQ1 and first data DTA1 from the host device 120, or may deliver the second request REQ2 and second data DTA2 to the host device 120 by receiving the TCP packet TPK from the network. The network interface device 140 according to an example embodiment of the present disclosure may be a smart network interface card based on a field-programmable gate array (FPGA), an application-specific integrated circuit (ASIC), or a system on chip (SoC).

The network interface device 140, according to an example embodiment of the present disclosure, may comprise a host interface 141, a TCP controller 142, a packet generator 143, and a receive parser 144.

The host interface 141 may perform an interface with the host device 120. Specifically, the host interface 141 may receive the first request REQ1 and the first data DTA1 from the host device 120, and transmit the second request REQ2 and the second data DTA2 to the host device 120. In this case, the host interface 141 may include a DMA controller to perform the transmission and reception of parameters and data to and from the host device 120 by way of DMA. The TCP controller 142 may generate a first header information HIF1 by performing TCP operations for the first request REQ1 received from the host device 120, and may generate the second request REQ2 by performing TCP operations for a second header information HIF2 extracted from the TCP packet TPK received from the network. The packet generator 143 may generate the TCP packet TPK by combining the TCP header corresponding to the first header information HIF1 and the payload corresponding to the first data DTA1 provided from the TCP controller 142. The receive parser 144 may deliver the second header information HIF2 corresponding to the TCP header to the TCP controller 142 by parsing the TCP packet TPK received from the network and deliver the payload as the second data DTA2 to the host device 120 via the host interface 141.

As described above, the network interface device 140 according to an example embodiment of the present disclosure may operate efficiently because it knows where to access the TCP data buffer TBF even if it only shares a sequence number of the first data DTA1 or the second data DTA2 with the host device 120. In addition, since the network interface device 140 according to an example embodiment of the present disclosure receives or transmits the first data DTA1 or the second data DTA2 by way of DMA, it may perform TCP operations independently and asynchronously from the host device 120. Thus, the network interface device 140 according to an example embodiment of the present disclosure, high-performance TOE operations may be supported while minimizing the burden on the host CPU.

Further, the network interface device 140 according to an example embodiment of the present disclosure may not have or use an internal buffer for buffering the first data DTA1 or the second data DTA2 of the host device 120. In order to ensure the reliability of TCP communication even in the event that the TCP packet TPK is lost or the order of the TCP packet TPK is changed in the network, it is required to buffer the data transmitted by the transmitting device of the TCP packet TPK until the server device 100 or the remote device 200 of FIG. 1 acknowledges the reception of the TCP packet TPK.

The network interface device 140 according to an example embodiment of the present disclosure may perform TCP operation using the first data DTA1 or the second data DTA2 stored in the TCP data buffer TBF of the host device 120. In this case, as described above, since the first data DTA1 or the second data DTA2 is written starting from the first transmit offset TX_APP and the second receive offset RX_RCV, the first data DTA1 or the second data DTA2 may be stored in the TCP data buffer TBF until it is acknowledged.

Thus, the network interface device 140 according to an example embodiment of the present disclosure may perform TCP operation without copying the first data DTA1 or second data DTA2 in the TCP data buffer TBF back to an internal buffer. This will be discussed in more detail below.

The host interface 141 may receive the first request “send ( )” including the first parameter PAR1 (S1-1) and deliver it to the TCP controller 142 (S1-2). The TCP controller 142 may deliver the first header information HIF1 to the packet generator 143 by performing TCP operation (S1-3).

Additionally, a first access signal XAC1 is transmitted to the host interface 141, and the host interface 141 may perform a DMA reception (reading out) into the TCP data buffer TBF in response to the first access signal XAC1 (S1-4). The first access signal XAC1 may include a sequence number of the first data DTA1 or an address of the TCP data buffer TBF corresponding to the sequence number of the first data DTA1.

FIG. 8 illustrates an example embodiment for the TCP controller 142 that outputs the first access signal XAC1 simultaneously with the generation of the first header information HIF1 or after the generation of the first header information HIF1, in order to facilitate and simplify the combining of the first header information HIF1 corresponding to the TCP header and the payload corresponding to the first data DTA1 by the passively operating packet generator 143. However, it is not limited thereto. According to an example embodiment of the present disclosure, the packet generator 143 may also transmit the first access signal XAC1 to the host interface 141, after receiving the first header information HIF1.

The host interface 141 may perform a DMA reception of the first data DTA1 stored in the region of the TCP data buffer TBF corresponding to the first access signal (S1-5). The first data DTA1 received on the host interface 141 may be delivered to the packet generator 143 without further copy inside the network interface device 140 (S1-6).

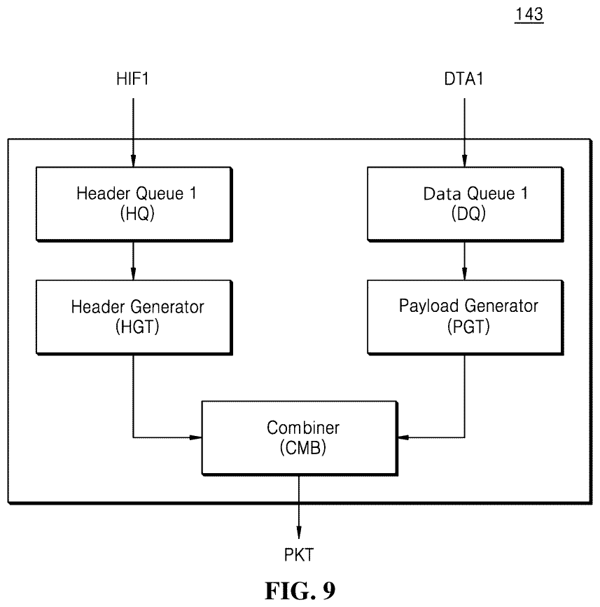

FIG. 9 is a diagram illustrating the packet generator 143, according to an example embodiment of the present disclosure.

Referring to FIGS. 1, 8, and 9, the packet generator 143 according to an example embodiment of the present disclosure may include a first header queue HQ1, a first data queue DQ1, a header generator HGT, a data generator DGT, and a combiner CMB.

The first header queue HQ1 may receive the first header information HIF1 from the TCP controller 142. The first data queue DQ1 may receive the first data DTA1 from the host interface 141. As described above, by coordinating the generation of the first header information HIF1 and the output of the first access signal XAC1 by the TCP controller 142, the first header information HIF1 and the first data DTA1 may be located at the same location (same index) in the first header queue HQ1 and the first data queue DQ1 without performing separate control.

The header generator HGT may generate a TCP header corresponding to the first header information HIF1 based on the TCP protocol. The payload generator PGT may generate a payload corresponding to the first data DTA1. In this case, the sequence number for the first data DTA1 included in the first parameter PAR1 described above may be the same or different from the sequence number in the TCP header of the TCP packet PKT. In the same way, the size of the first data DTA1 and the size of the payload may be the same or different. For example, the network interface device 140 may generate the TCP packet TPK with a size of the payload different from the first data DTA1 of the first request REQ1 based on system resources or network conditions, and in this case, the sequence number in the TCP header may be set differently from the sequence number in the first parameter PAR1.

The combiner CMB may combine the TCP header and payload to generate the TCP packet TPK.

Therefore, the network interface device 140 according to an example embodiment of the present disclosure may process the first data DTA1 received at the host interface 141 as the TCP packet TPK without performing any additional buffering operation on the first data DTA1 and directly deliver it to the packet generator 143. Thus, memory usage in the network interface device 140 may be significantly reduced.

Referring again to FIGS. 1 and 8, the first data DTA1 is not copied internally in the network interface device 140, so that when the TCP packet TPK generated by the packet generator 143 is transmitted to the network, the first data DTA1 no longer exists in the network interface device 140. In this case, “no longer exist” means that the network interface device 140 does not intentionally store or buffer the first data DTA1 of the TCP packet TPK internally for any processing or purpose after the transmission of the TCP packet TPK, and does not mean that it includes unintentional storage state which may happen on most computing systems.

The network interface device 140 according to an example embodiment of the present disclosure may generate the TCP packet PKT via the above operations. In addition, the network interface device 140 according to an example embodiment of the present disclosure may process the TCP packet PKT received over the network as follows.

When the receive parser 144 receives the TCP packet PKT from the network (S2-1), it may deliver the second data DTA2 corresponding to the payload of the TCP packet PKT to the host interface 141 (S2-2) to perform a DMA transmission (writing) to the TCP data buffer TBF (S2-3). In this case, the second data DTA2 may be stored in an area of the TCP data buffer TBF corresponding to a sequence number of the packet data PDT. Similar to the relationship between the first data DTA1 and the payload described above, the second data DTA2 may be generated in a size different from the payload.

Simultaneously, the receive parser 144 may deliver the second header information HIF2 of the received TCP packet PKT to the TCP controller 142 (S2-4), and the TCP controller 142 may perform TCP operation on it to generate the second request REQ2 including the second parameter PAR2. After that, when a request for receiving the second data DTA2 from the host device 120, such as a doorbell signal XDB, is received (S2-5), the second request REQ2 including the second parameter PAR2 may be delivered to the host device 120 (S2-6, S2-7). In this case, as described above, the TCP controller 142 may first deliver the second request REQ2 to the host device 120 before receiving the doorbell signal XDB (S2-6).

Just as the first data DTA1 is no longer present on the network interface device 140 when the TCP packet TPK generated by the packet generator 143 is transmitted to the network, the second data DTA2 is no longer present on the network interface device 140 when the second data DTA2 is transmitted to the host device 120 via the host interface 141. In this case, the meaning of ‘does not exist’ is also as described above.

In this manner, the network interface device 140 according to an example embodiment of the present disclosure may process the TCP packets TPK by delivering the second data DTA2 directly to the host interface 141 without performing additional buffering operation, where the second data DTA2 is processed by the receive parser 144. Thus, memory usage in the network interface device 140 may be significantly reduced.

Although not shown, the network interface device 140 according to an example embodiment of the present disclosure may further include a scheduler, internal memory, and the like. Further, the network interface device 140 according to an example embodiment of the present disclosure may further include separate modules for supporting other network protocols other than TCP/IP, such as Internet Control Message Protocol (ICMP), Address Resolution Protocol (ARP), and the like, and may perform link layer routing, and the like, through such processing modules.

According to an example embodiment of the present disclosure, a server device may include: a TCP data buffer configured to store a first data of a first request to be transmitted to a network, and a first command queue configured to store a first parameter of the first request including a first sequence number for the first data; and an interface device configured to receive the first parameter from the first command queue, fetch the first data from a region of the TCP data buffer corresponding to the first sequence number, and generate a first TCP packet for the first request.

According to an example embodiment of the present disclosure, the network interface device may include: a TCP controller configured to output a first header information by performing a TCP operation for the first parameter, a host interface configured to receive the first data by way of a direct memory access (DMA) from the TCP data buffer in response to a first access signal; and a packet generator configured to generate the first TCP packet by receiving the first header information from the TCP controller, and receiving the first data from the host interface.

According to an example embodiment of the present disclosure, the first data may be delivered to the packet generator from the host interface without being buffered or copied.

According to an example embodiment of the present disclosure, the network interface device may further include: a receive parser configured to extract a second header information from a second TCP packet received from the network, and transmit a second data to the host interface without being buffered or copied.

According to an example embodiment of the present disclosure, the host interface may transmit the second data by way of the DMA to a region corresponding to a second sequence number for the second data, within the TCP data buffer.

According to an example embodiment of the present disclosure, the host device may further include: a TCP session table configured to store a pair of transmit offsets and a pair of receive offsets corresponding to the first sequence number and the second sequence number and representing a state of the TCP data buffer for each TCP session.

According to an example embodiment of the present disclosure, one of the pair of transmit offsets may be updated when the transmission of the first data is acknowledged, and one of the pair of receive offsets may by updated when the reception of the second data is acknowledged.

According to an example embodiment of the present disclosure, the host device may further include: a second command queue configured to receive and store the second parameter corresponding to the second header information from the network interface device.

According to an example embodiment of the present disclosure, the first sequence number may be different from a sequence number of a TCP header of the first TCP packet.

According to an example embodiment of the present disclosure, the TCP data buffer may be addressed by a number of least significant bits of the first sequence number corresponding to a size of the TCP data buffer.

According to an example embodiment of the present disclosure, the TCP data buffer may include sub-buffer regions corresponding to each TCP session.

According to an example embodiment of the present disclosure, a network interface device may include: a TCP controller configured to generate a first header information by performing a TCP operation on a received first request; a host interface configured to receive a first data corresponding to the first request from an external source in response to a first access signal that includes an information corresponding to a sequence number for a first data of the first request; and a packet generator configured to generate a first packet corresponding to the first request by receiving the first header information from the TCP controller, and receiving the first data from the host interface.

According to an example embodiment of the present disclosure, the host interface may include: a DMA controller configured to transmit the first data by way of a direct memory access.

According to an example embodiment of the present disclosure, the first data may be delivered from the host interface to the packet generator without being buffered or copied.

According to an example embodiment of the present disclosure, the packet generator may include: a first header queue configured to receive the first header information from the TCP controller, a first data queue configured to receive the first data from the host interface, a header generator configured to generate a TCP header of the first TCP packet by receiving the first header information from the first header queue; a payload generator configured to receive the first data from the first data queue and process it as a payload of the first TCP packet; and a combiner configured to combine the TCP header and the payload and output it as the first PCT packet.

According to an example embodiment of the present disclosure, the network interface device may further include: a receive parser configured to extract a second header information and a second data from a second TCP packet received from a network, and transmit the second data to the host interface without being buffered or copied.

According to an example embodiment of the present disclosure, when the first TCP packet is transmitted externally by the packet generator or the second data is transmitted externally by the host interface, neither the first data nor the second data may be present within the network interface device.

According to an example embodiment of the present disclosure, the network interface device may not include an internal buffer to buffer the first data or the second data until an ACK processing corresponding to the transmission of the first data or the reception of the second data is completed.

According to an example embodiment of the present disclosure, the first access signal may be output from the TCP controller simultaneously with the generation of the first header information or after the first header information is generated.

According to an example embodiment of the present disclosure, a method of operating of the network interface device may include: receiving the first request from the external source by the host interface; generating the first header information by performing the TCP operation for the first request by the TCP controller; receiving the first data from an external source by way of DMA, in response to the first access signal, by the host interface; and generating the first TCP packet by receiving the first header information from the TCP controller, and by receiving the first data from the host interface without being buffered or copied by the packet generator.

The various embodiments and terms used herein are not intended to limit the technical features described herein to specific embodiments and should be understood to include various modifications, equivalents, or substitutes of the example embodiments. For example, an element expressed in a singular should be understood as a concept including a plurality of elements unless the context clearly refers only the singular. It should be understood that the term ‘and/or’ as used herein is intended to encompass any and all possible combinations of one or more of the enumerated items. As used in the present disclosure, the terms such as ‘comprise(s)’, ‘include(s)’ ‘have/has’, ‘configured of’, etc. are only intended to designate that the features, components, parts, or combinations thereof described in the present disclosure exist, and the use of these terms is not intended to exclude the possibility of the presence or addition of one or more other features, components, parts, or combinations thereof. In the present disclosure, each of the phrases such as “A or B”, “at least one of A and B”, “at least one of A or B”, “A, B or C”, “at least one of A, B and C”, and “at least one of A, B, or C” may include any one of the items enumerated together in a corresponding one of the phrases, or all possible combinations thereof. Terms such as “the first”, “the second”, or “first”, or “second” may be used simply to distinguish a corresponding component from another corresponding component, and do not limit the corresponding components in view of other aspect (e.g., importance or order).

The term “unit”, “block” or “module” used in various embodiments of the present disclosure may include a unit implemented in hardware, software, or firmware, or any combination thereof, and be used interchangeably with terms such as e.g., logic, logic block, part, component, or circuitry, for example. The unit, block or module may be a minimum unit or a part of the integrally configured component or the component that performs one or more functions. For example, according to an example embodiment, the unit, block or module may be implemented in the form of an ASIC or a FPGA.

The term “in case ˜” used in various embodiments of the present disclosure, may be construed to refer, for example, to “when ˜”, or “in response to determining ˜” or “in response to detecting ˜”, depending on the context. Similarly, the term “when it is determined that ˜” or “when it is detected that ˜” may be interpreted to refer, for example, to “upon determining ˜” or “in response to determining ˜”, or “upon detecting ˜” or “in response to detecting ˜”, depending on the context.

The program executed by the TOE-based network interface device 140 and the server device 100 described herein may be implemented as a hardware component, a software component, and/or a combination of the hardware component and the software component. The program may be executed by any system capable of executing computer readable instructions.

Software may include a computer program, codes, instructions, or a combination of one or more of these, and may configure a processing unit to perform operations as desired or command the processing unit independently or in combination (collectively). The software may be implemented as a computer program including instructions stored in a computer-readable storage medium. The computer-readable storage medium may include, for example, a magnetic storage medium (e.g., read-only memory (ROM), random-access memory (RAM), floppy disk, hard disk, and so on), an optically readable medium (e.g., CD-ROM, digital versatile disc (DVD), or the like) and so on. The computer-readable storage medium may be distributed among network-connected computer systems, so that the computer-readable code may be stored and executed in a distributed manner. The computer program may be distributed (e.g., downloaded or uploaded) by online, either via an application store (e.g. Play Store™) or directly between two user devices (e.g., smartphones). In the case of online distribution, at least a part of the computer program product may be temporarily stored or temporarily generated in a machine-readable storage medium such as a memory of a server of a manufacturer, a server of an application store, or a relay server.

According to various embodiments, each component (e.g., module or program) of the above-described components may include a singular or a plurality of entities, and some of the plurality of entities may be separated and placed into other components. According to various embodiments, one or more components or operations among the above-described corresponding components may be omitted, or one or more other components or operations may be added thereto. Alternatively or additionally, a plurality of components (e.g., a module or a program) may be integrated into one component. In this case, the integrated component may perform one or more functions of each component of the plurality of components identically or similarly to those performed by the corresponding component among the plurality of components prior to the integration. According to various embodiments, operations performed by a module, program, or other component may be executed sequentially, in parallel, repeatedly or heuristically, or one or more of the operations may be executed in a different order or omitted, or one or more other operations may be added thereto.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the example embodiment(s) described herein may be used in conjunction with any other example embodiment(s) described herein.

What is claimed is:

1. A server device comprising:
a host device including a TCP data buffer configured to store a first data of a first request to be transmitted to a network, and a first command queue configured to store a first parameter of the first request including a first sequence number for the first data; and
an interface device configured to receive the first parameter from the first command queue, fetch the first data from a region of the TCP data buffer corresponding to the first sequence number, and generate a first TCP packet for the first request.

2. The server device of claim 1, wherein the network interface device comprises:
a TCP controller configured to output a first header information by performing a TCP operation for the first parameter,
a host interface configured to receive the first data by way of a direct memory access (DMA) from the TCP data buffer in response to a first access signal; and
a packet generator configured to generate the first TCP packet by receiving the first header information from the TCP controller, and receiving the first data from the host interface.

3. The server device of claim 2, wherein the first data is delivered to the packet generator from the host interface without being buffered or copied.

4. The server device of claim 2, wherein the network interface device further comprises:
a receive parser configured to extract a second header information from a second TCP packet received from the network, and transmit a second data to the host interface without being buffered or copied.

5. The server device of claim 4, wherein the host interface transmits the second data by way of the DMA to a region corresponding to a second sequence number for the second data, within the TCP data buffer.

6. The server device of claim 5, wherein the host device further comprises:
a TCP session table configured to store a pair of transmit offsets and a pair of receive offsets corresponding to the first sequence number and the second sequence number and representing a state of the TCP data buffer for each TCP session.

7. The server device of claim 6, wherein one of the pair of transmit offsets is updated when the transmission of the first data is acknowledged, and one of the pair of receive offsets is updated when the reception of the second data is acknowledged.

8. The server device of claim 4, wherein the host device further comprises:
a second command queue configured to receive and store the second parameter corresponding to the second header information from the network interface device.

9. The server device of claim 2, wherein the first sequence number is different from a sequence number of a TCP header of the first TCP packet.

10. The server device of claim 1, wherein the TCP data buffer is addressed by a number of least significant bits of the first sequence number corresponding to a size of the TCP data buffer.

11. The server device of claim 1, wherein the TCP data buffer comprises sub-buffer regions corresponding to each TCP session.

12. A network interface device comprising:
a TCP controller configured to generate a first header information by performing a TCP operation on a received first request;
a host interface configured to receive a first data corresponding to the first request from an external source in response to a first access signal that includes an information corresponding to a sequence number for a first data of the first request; and
a packet generator configured to generate a first packet corresponding to the first request by receiving the first header information from the TCP controller, and receiving the first data from the host interface.

13. The network interface device of claim 12, wherein the host interface comprises:
a DMA controller configured to transmit the first data by way of a direct memory access.

14. The network interface device of claim 12, wherein the first data is delivered from the host interface to the packet generator without being buffered or copied.

15. The network interface device of claim 12, wherein the packet generator comprises:
a first header queue configured to receive the first header information from the TCP controller,
a first data queue configured to receive the first data from the host interface,
a header generator configured to generate a TCP header of the first TCP packet by receiving the first header information from the first header queue;
a payload generator configured to receive the first data from the first data queue and process it as a payload of the first TCP packet; and
a combiner configured to combine the TCP header and the payload and output it as the first PCT packet.

16. The network interface device of claim 12, further comprises:
a receive parser configured to extract a second header information and a second data from a second TCP packet received from a network, and transmit the second data to the host interface without being buffered or copied.

17. The network interface device of claim 16, wherein when the first TCP packet is transmitted externally by the packet generator or the second data is transmitted externally by the host interface, neither the first data nor the second data is present within the network interface device.

18. The network interface device of claim 16, wherein the network interface device does not comprise an internal buffer to buffer the first data or the second data until an ACK processing corresponding to the transmission of the first data or the reception of the second data is completed.

19. The network interface device of claim 12, wherein the first access signal is output from the TCP controller simultaneously with the generation of the first header information or after the first header information is generated.

20. A method of operating the network interface device of claim 12, the method comprising:
receiving the first request from the external source by the host interface;
generating the first header information by performing the TCP operation for the first request by the TCP controller;
receiving the first data from an external source by way of DMA, in response to the first access signal, by the host interface; and
generating the first TCP packet by receiving the first header information from the TCP controller, and by receiving the first data from the host interface without being buffered or copied by the packet generator.
